(19) United States
(12) Patent Application Publication
(10) Pub. No.: US 2007/0130588 A1
(43) Pub. Date: Jun. 7, 2007

(54) User-customized sound themes for television set-top box interactions

(76) Inventors: Greg Edwards, Austin, TX (US); Jeff Brandt, Cedar Park, TX (US); Philip Kortum, Houston, TX (US); Marc Sullivan, Austin, TX (US)

Correspondence Address: MATTHEW E. BURR;LAKE AUSTIN MARINA, 2219 WESTLAKE DR, STE 200, AUSTIN, TX, 78746, US

(21) Appl. No.: 11/295,156

(22) Filed: Dec. 6, 2005

(51) Int. Cl. H04N 5/445; H04N 7/173

(52) U.S. Cl. 725/59; 725/87

(57) ABSTRACT

Television sound themes for a set-top box interactive television system may be customized for each member of a household. Machine-readable media may provide customization logic and user interface logic. Sounds for a user-customized television system sound theme may be drawn from a digital audio file source. Logic components and the digital sound file source for a television sound theme system may reside locally at the set-top box, or may be accessed remotely over a network.

### FIELD OF THE DISCLOSURE

The present disclosure relates to television audio, and in particular to methods, systems and networks to provide user-customized sound themes for television set-top box interactions.

### BACKGROUND

Digital television, Internet Protocol television (IPTV), and digital video recording (DVR) systems have raised the demand for new interactive functionalities to accompany television viewing. For example, there are now integrated ways to show picture slide shows and play recorded music from a personal computer, as well as to watch rented or pay-per-view movies directly on a TV.

Exploiting the interactive television functions typically involves a set-top box (STB) and using an STB remote control to bring up a menu on the television screen. STB remote controls typically feature scroll and select functions so that a viewer can scroll through the menu options and select the one of interest. Scrolling and selecting through a television menu system may be referred to as navigating the system.

Some STB devices may provide simple auditory feedback to accompany navigation actions. Interactions such as a menu item selection or an inappropriate action may generate a simple tone similar to the sound that accompanies a basic computer interface action. Frequent occurrence of the alert may cause the alert sound to become annoying.

### BRIEF DESCRIPTION OF THE DRAWINGS

The present disclosure continues, in the detailed description that follows by way of non-limiting examples of embodiments of the present disclosure, by reference to the noted drawings, in which reference numerals represent the same parts throughout the several views of the drawings, and in which:

FIG. 1 is a process flow illustration of a process of a specific exemplary embodiment of the present disclosure.

FIG. 2 is a diagrammatic representation of a system of a specific exemplary embodiment of the present disclosure.

FIG. 3 is a diagrammatic representation of a system of a specific exemplary alternative embodiment of the present disclosure.

FIG. 4 is a diagrammatic representation of a system of another specific exemplary alternative embodiment of the present disclosure.

FIG. 5 is a diagrammatic representation of a machine in the form of a computer system 500 within which a set of instructions, when executed, may cause the machine to perform any one or more of the methodologies discussed herein.

FIG. 6 is a diagrammatic representation of a specific exemplary embodiment of a network of the present disclosure.

### DETAILED DESCRIPTION

In view of the foregoing, the present disclosure, through one or more various aspects, embodiments and/or specific features or sub-components described, is thus intended to bring out one or more of the advantages that will be evident from the description. The present disclosure is described with frequent reference to set-top boxes. It is understood, however, that a set-top box is merely an example of a specific embodiment of the present disclosure, which is directed broadly to interactive television within the scope of the disclosure. The terminology, examples, drawings and embodiments, therefore, are illustrative and not intended to limit the scope of the disclosure. For the purposes of the description, the terms “audio” and “sound” may used interchangeably merely for illustrative purposes and not to limit the scope of the present disclosure.

The present disclosure describes approaches to customize audio feedback for interactive television so that user-defined sounds may be heard to indicate selected alerts, events, actions, functions or operations performed by the STB automatically or at the user's command.

Television sound themes for an STB interactive television interface may be customized for each member of the household. Each theme, for example, may provide a suite of different auditory feedback sounds based on a common theme, such as, for example, a popular children's' cartoon for children, or ocean sounds for those that love the ocean. The user ends up with a user-customized system for pleasant or entertaining auditory feedback when operating a television system, and which audio feedback may be personalized to each user of the television system.

Within the suite of sounds in a theme, each sound may be associated with an assigned interaction, event, alert or other designated operation of the STB, or, more generally, of the television system. For example, upon successfully scheduling a program to record on a Digital Video Recorder (DVR), the STB plays a sound of hands clapping an ovation. Upon deleting a DVR recorded program, the STB may play the sound of a balloon popping, and so forth. The user may download new discreet sounds or entire sound themes from the STB manufacturer, television service provider, third party providers or from the public domain.

Sound themes of the present disclosure may extend to viewing DVD movies or other video and audio content. In such embodiments, the controls that act on that video have auditory feedback that directly relates to that program if the viewer so chooses. A user watching a robot movie, for example, might get the voice of the main character robot saying “movie has been terminated” when they press the stop key.

In additional alternative embodiments, one or more selected sound themes may be assigned to each user in a household, for example, such that when a specific user is interacting with the system, a system of the present disclosure detects which user it is and provides their favorite sound theme, or the system may present a menu from which the identified user may select the sound theme he or she is in the mood for at that time. The detection mechanism may be, for example, one or more of a variety of biometrics, login passwords, or any other identification method or combination of identifiers.

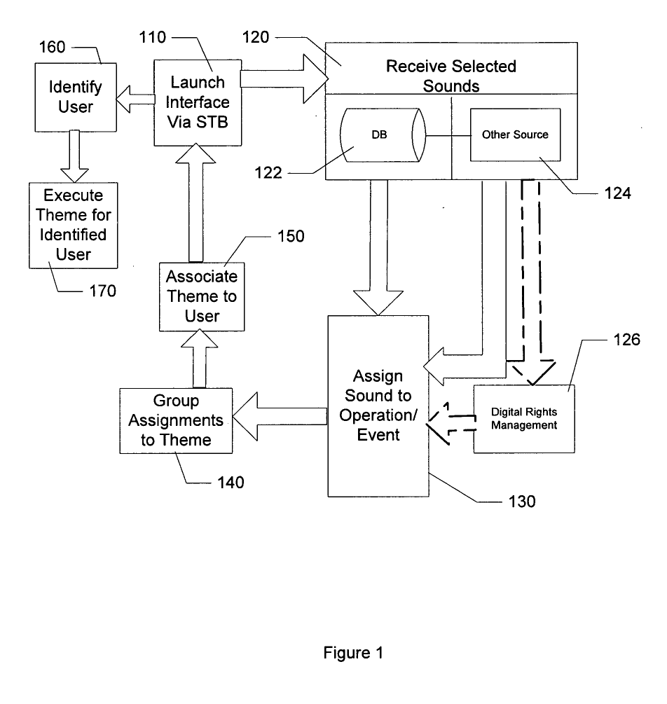

Turning now to the drawings, FIG. 1 is a process flow illustration of a process of a specific exemplary embodiment of the present disclosure. A set-top box launches a user interface 110 in response to a user command from an STB remote control device, for example, and displays the interface on a television screen display. The STB receives sounds 120 from a sound file database 122, for example, or from another source 124 such as a DVD or a Web site.

The present disclosure contemplates that any digital audio file format may be adapted for use in a sound theme, including, for example, uncompressed formats, such as WAV, AIFF and AU; formats with lossless compression, such as FLAC, Monkey's Audio (filename extension APE), WavPack, Shorten, TTA and lossless Windows Media Audio (WMA); formats with lossy compression, such as MP3, Ogg Vorbis (filename extension OGG), and lossy Windows Media Audio (WMA) and AAC. Additionally, audio data from AVI files or from a DVD may be adapted for use in the present system. Similarly the present disclosure contemplates any audio file codec may be adapted for audio playback in a system of the present disclosure.

Certain alternative embodiments of the present disclosure allow for a user to acquire rights to proprietary sounds or entire proprietary sound themes or suites. For example, the purchase of a television series DVD may come with a sound theme using sounds from the TV show, including theme music, actor voices, distinctive sounds effects and so forth. Accordingly, an STB of the present disclosure may include digital rights management (DRM) logic 126 (shown in FIG. 1 as a parallel or an alternative process flow path by dotted arrows) to manage access to and use of such proprietary material, together with storage of such acquired sounds in the user's database 122.

Selected sounds may be assigned 130, via the interface, to specific events, alerts, operations, functions, actions and so forth. Assigned sounds may be grouped to create a sound theme, suite or scheme 140 which may be associated 150 to the user. Each user in a household may have as many sound themes as he or she desires. User interface 110 may facilitate identifying 160 a particular user having one or more sound themes associated to the user, and the system may execute 170 the theme of the identified user. If the identified user has more than one theme associated with him or her, than the interface may present a menu of themes from which the identified user may select a desired theme.

A system of the present disclosure may be referred to as a controller of a television system. Such controller may include sound theme logic and user interface logic, as well as a source of digital audio information. Examples of television system operations to which a controller of the present disclosure may assign an audio file for playback upon occurrence of the operation include, but are not necessarily limited to, display of an on-screen menu; selection of an item from the on-screen menu; and exiting the on-screen menu.

Where the television system has a digital video recording system, the designated operations of the television system may include commencement of digital video recording; termination of a digital video recording; displaying an alert; a scheduled recording conflict alert; and displaying a program reminder.

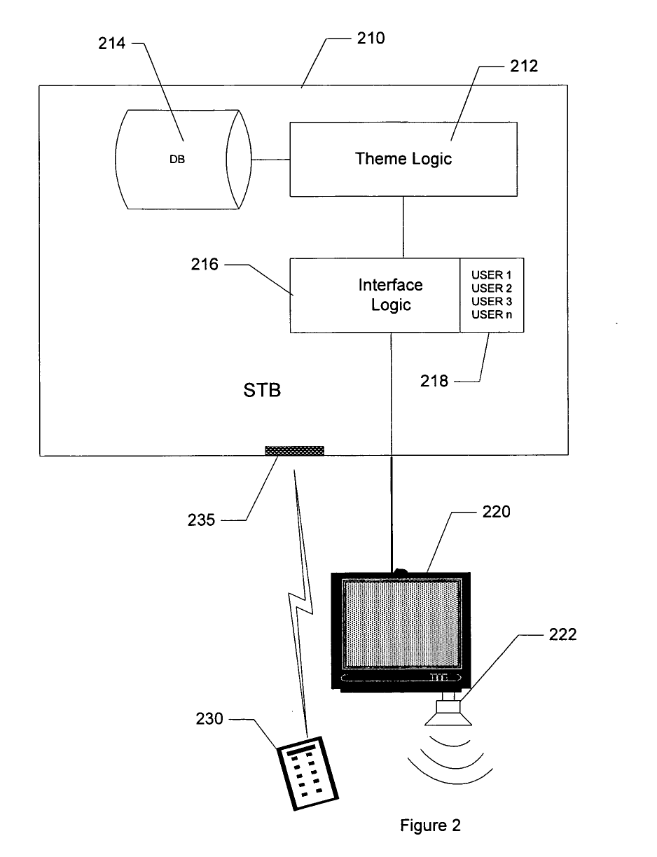

FIG. 2 is a diagrammatic representation of a system of a specific exemplary embodiment of the present disclosure. Set-top box 210 may include theme logic module 212 in communication with digital audio file or audio information database 214. Theme logic 212 may perform operations to assign selected sounds to an event, for example; to group assigned sounds to create a theme and to associate a theme with a specific user. Interface logic module 216 may perform operations to display a user interface at television display 220 connected to STB 210. Each user in a household, user 1 through user “n” 218 may access and edit their themes via interface logic module 216 in communication with theme logic module 212. STB remote control 230 via sensor 235 may be used to navigate the interface through television 220. Sounds of a selected theme may be made audible through speaker 222 connected to television 220.

A television system of the present disclosure may include, but not necessarily be limited to, a television 220 display terminal; set-top box 210; remote control 235; audio playback system 222, and may optionally further include home entertainment components such as an audio amplifier, compact disk player, one more speakers, DVD player; VCR; and so forth. Set-top box 210 may include a digital video recording (DVR) system for instant or schedule program recording; pause, rewind and fast forward functions for live or recorded programs; and other DVR operations.

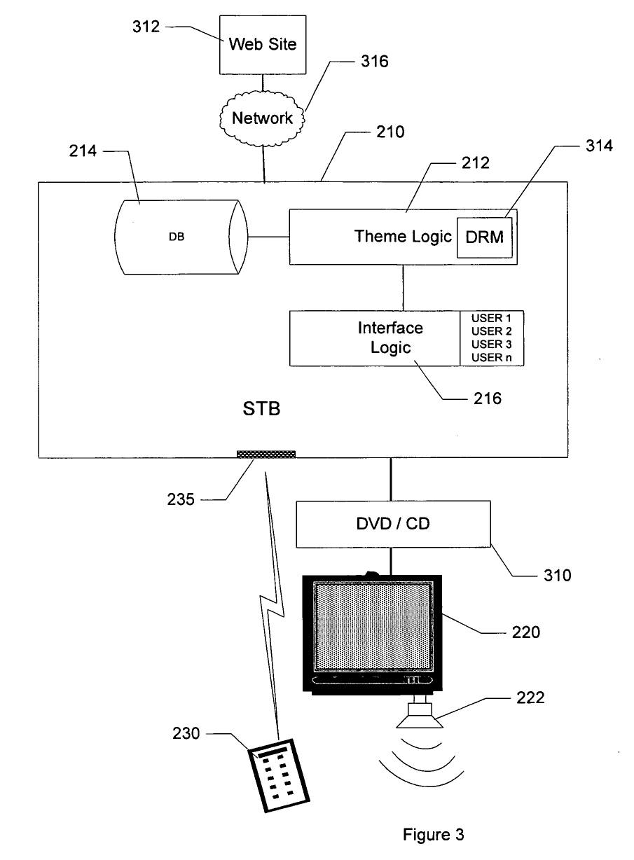

FIG. 3 is a diagrammatic representation of a system of a specific exemplary alternative embodiment of the present disclosure. In the embodiment of FIG. 3, STB 210 receives the audio files or audio instructions from a source other than database 214, such as, for example, one or more DVD player, CD player, home theater system, and the like 310; or Web site 312, which may be accessed from STB 210 via network 316. Digital Rights Management module 314 may manage the acquisition and compliance instructions that may be attached to the use of audio files obtained from the other source 310, 312. Alternative embodiments may allow audio files obtained from the other source 310, 312, and having permission, to be stored in database 214 for use by a user when other source 310, 312 is not in use.

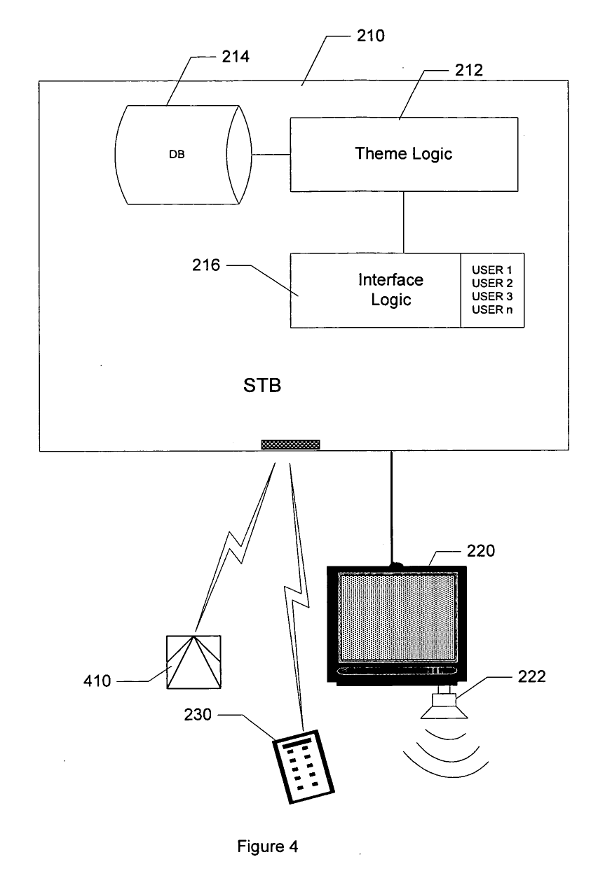

FIG. 4 is a diagrammatic representation of a system of another specific exemplary alternative embodiment of the present disclosure. A household, for example, may have a plurality of users 218 using the same set-top box 210. Interface logic module may display a user interface having or in communication with a user identifier. The user identifier may be, for instance, a screen name and/or a password; or a menu of user identifiers, such as screen names or nick names, from which a specific user may select a name; and so forth. Additionally or alternatively, the user identifier of a system of the present disclosure may include sensor 410 to identify a specific user. Sensor 410 may identify a user by, for example, one or more biometric identifying indicia, such as, for example, one or more fingerprint; voice recognition; eye patterns; image recognition such as facial recognition technology, and so forth.

For embodiments in which user identification exploits a biometric such as voice, fingerprint, or facial recognition technology, for example, a user interface may facilitate user identification in combination with the biometric under circumstances, for instance, when more than one user is present. For example, an on-screen menu that lists the household users may be displayed so that a particular user may be selected with the STB remote control 230, and the biometric may used to verify the identity of the selected user. Alternatively, if the biometric is voice recognition, for example, and the biometric technology is unable to resolve the user due more than one voice being present or due to high ambient noise, a user interface may facilitate user identification by allowing user selection and verification with appropriate input.

Theme logic 212 may automatically execute the theme of the identified user where, for example, the user has a single associated theme or has set a preference for a selected theme. A given user, however, may have more than one theme associated with him or her. Accordingly, a system of the present disclosure may enable interface logic module 216 to display a menu, for example, of all the user's themes from which the user may select, for example, a desired theme; set a preference for a selected theme to execute automatically upon user identification; or edit, add or delete themes. Additionally or alternatively, selected themes may be optionally password protected to enhance user privacy.

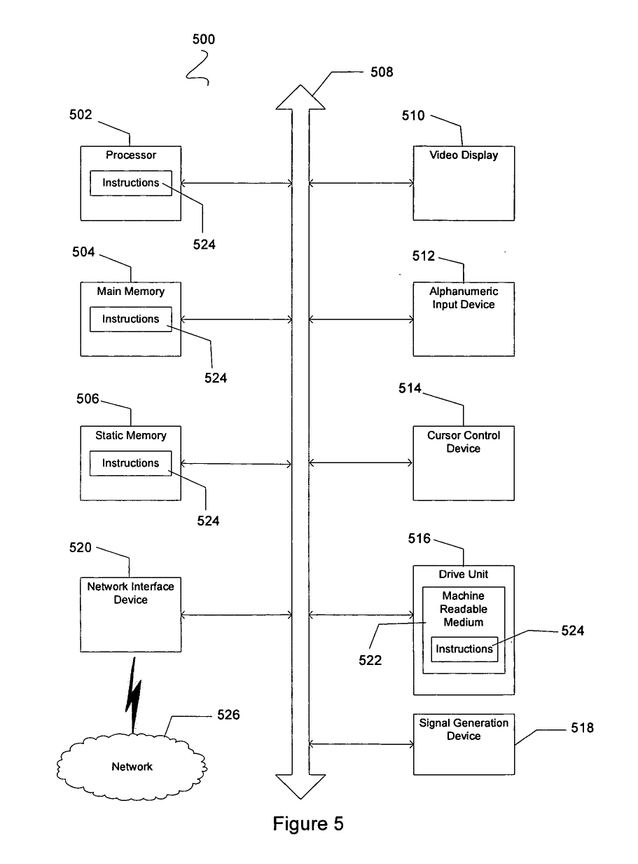

FIG. 5 is a diagrammatic representation of a machine in the form of a computer system 500 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse or a remote control), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the description is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

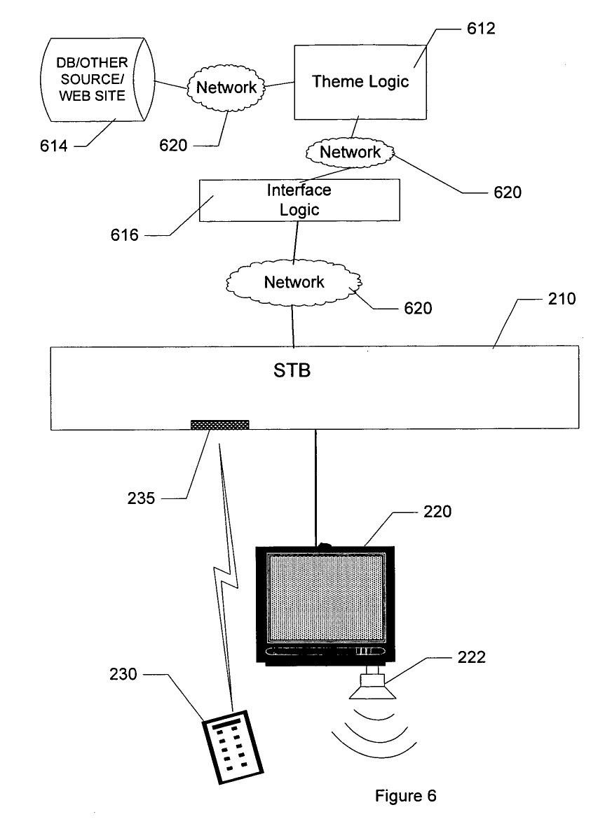

FIG. 6 is a diagrammatic representation of a specific exemplary embodiment of a network of the present disclosure. In the embodiment of FIG. 6, STB 210 may reside locally at a user premises. One or more of database or audio information source 614, theme logic module 612, or interface logic module 616, however, may be remote from the user premises yet in communication with each other and with STB 210 via one or more network 620.

A network embodiment of FIG. 6 advantageously allows a service provider to offer the benefits of an audio feedback theme system of the present disclosure without the need to replace the existing customer STB. That is, one or more of the functionalities described herein may be provided though networked modalities remote from a customer premises and offered to a customer as a service enhancement.

It is understood that the present disclosure contemplates any combination of local and remote/networked components to yield a television sound theme system of the present disclosure. For instance, a system of the present disclosure may take advantage of existing local STB interface logic and simply provide expanded memory 614 or theme processing logic 612 remotely through a network. Additionally, sound themes of the present disclosure may be adapted (e.g., formatted for Dolby® 5.1) to play back through a home theater system or other television audio enhancement system.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The disclosure has been described with reference to several exemplary embodiments. It is understood, however, that the words that have been used are words of description and illustration, rather than words of limitation. Changes may be made within the purview of the appended claims, as presently stated and as amended, without departing from the scope and spirit of the disclosure in all its aspects. Although the disclosure has been described with reference to particular means, materials and embodiments, the disclosure is not intended to be limited to the particulars disclosed; rather, the disclosure extends to all functionally equivalent technologies, structures, methods and uses such as are within the scope of the appended claims.

We claim:

1. A machine-readable medium containing instructions that, when executed by a machine in communication with a television system having a display terminal and an audio playback system, the instructions cause the machine to:
launch a user interface at the television display terminal;
receive one or more digital sound files selected via the user interface from a digital sound file source;
assign at least one of the received digital sound files to a selected operation of the television system;
group at least one of the assigned digital sound files to a designated sound theme; and
associate the designated sound theme with a user.

2. The medium of claim 1, wherein the sound file source comprises a database.

3. The medium of claim 2, wherein the database is local to the machine.

4. The medium of claim 2, wherein the database is remote from and in communication with the machine.

5. The medium of claim 1, wherein the sound file source comprises a third-party source.

6. The medium of claim 5, wherein the third-party source comprises a digital video disk (DVD).

7. The medium of claim 5, wherein the third-party source comprises a web site.

8. The medium of claim 1, wherein the instructions further cause the machine to perform one or more Digital Rights Management operation for proprietary sound files.

9. The medium of claim 1, wherein the instructions further cause the machine to identify the user.

10. The medium of claim 9 wherein the instructions further cause the machine to execute the sound theme for the identified user.

11. The medium of claim 9, wherein the instructions to identify the user comprise accepting a user selection input.

12. The medium of claim 9, wherein the instructions to identify the user comprise accepting biometric input.

13. The medium of claim 1, wherein the medium is housed in a television set-top box.

14. The medium of claim 13, wherein digital sound file source is remote from the set-top box.

15. A controller for a television system, the controller comprising:
one or more machine-readable media containing instructions, wherein at least one machine-readable medium comprises a digital audio file source, and wherein the instructions comprise audio theme logic and user interface logic for user-customized audio playback of one or more digital audio files, each digital audio file being assigned to a designated operation of the television system for playback upon the occurrence of the designated operation.

16. The controller of claim 13, wherein the controller resides within a set-top box.

17. The controller of claim 13, wherein the controller is adapted to process input from a remote control.

18. The controller of claim 13, wherein the controller is connected to a communication network.

19. The controller of claim 13, wherein the designated operation of the television system comprises display of an on-screen menu.

20. The controller of claim 17, wherein the designated operation of the television system comprises selection of an item from the on-screen menu.

21. The controller of claim 17, wherein the designated operation of the television system comprises exiting the on-screen menu.

22. The controller of claim 13, wherein the television system comprises a digital video recording system, and further wherein the designated operation of the television system comprises commencement of digital video recording.

23. The controller of claim 20, wherein the designated operation of the television system comprises termination of a digital video recording.

24. The controller of claim 20, wherein the designated operation of the television system comprises displaying an alert.

25. The controller of claim 22, wherein the alert comprises a scheduled recording conflict alert.

26. The controller of claim 13, wherein the designated operation of the television system comprises displaying a program reminder.

27. A sound theme system for user-customized audio playback of one or more digital audio file, each digital audio file being assigned to play upon the occurrence of a designated operation of a television system, the system comprising:
sound theme logic to:
assign one or more selected digital audio files to one or more designated operations of the television system,
group two or more assigned digital audio files to form one or more themes,
associate one or more of the themes to one or more users, and
execute at least one of the themes for at least one of the users; and
sound theme user interface logic to provide a user interface at a display of the television system.

28. The sound theme system of claim 25, further comprising a digital audio file source connected to the television system.

29. The sound theme system of claim 25, wherein the system is housed in a set-top box.

30. The sound theme system of claim 25, further comprising a television system remote control for the user interface.

31. The sound theme system of claim 25, further comprising a user identifier connected to the television system to identify at least one of the users.

32. The sound theme system of claim 25, wherein the television system comprises a television display connected to at least one audio speaker.

33. The sound theme system of claim 30, the television system further comprising a digital video disk (DVD) player connected to the television display, wherein the digital audio file source comprises a DVD.

34. The sound theme system of claim 30, the television system further comprising a compact disk (CD) player connected to the television speaker, wherein the digital audio file source comprises a CD.

35. The sound theme system of claim 30, the television system further comprising a home theater system connected to the television display.

36. The sound theme system of claim 25, further comprising a communication network linking one or more nodes, wherein one or more of the theme logic; the user interface logic; or one or more digital audio file sources, reside in one or more of the nodes.

37. A communication network linking one or more nodes for user-customized audio playback of one or more digital audio files assigned to a designated operation of a television system for playback upon the occurrence of the designated operation, the communication network comprising:
one or more information transmission media; and
two or more nodes linked by one or more of the information transmission media; wherein one or more of the following reside in one or more of the nodes:
television sound theme logic to perform one or more of the following: assign at least one of the digital audio files to the designated operation, group one or more of the assigned audio files to a television sound theme, associate the television sound theme to a user and execute the television sound theme for the user; and
television sound theme user interface logic for a television sound theme user interface.

38. The communication network of claim 37, wherein at least one of the nodes further comprises a set-top box with one or more of the following: the theme logic module; the user interface module; or a digital audio file source.

39. The communication network of claim 37, wherein at least one of the nodes further comprises further comprises one or more digital audio file sources.

40. The communication network of claim 39, wherein at least one of the digital audio file sources comprises a website.
